(19) United States
(12) Patent Application Publication
(10) Pub. No.: US 2006/0075082 A1
(43) Pub. Date: Apr. 6, 2006

(54) Content distribution system and content distribution method

(76) Inventors: Futoshi Haga, Sagamihara (JP); Yutaka Kudo, Yokohama (JP); Takeshi Ishizaki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/998,754

(22) Filed: Nov. 30, 2004

(30) Foreign Application Priority Data
Sep. 2, 2004 (JP) 2004-255614

(51) Int. Cl. G06F 15/173

(52) U.S. Cl. 709/223

(57) ABSTRACT

The addition of IT resources is suppressed smaller when a service area of a content distribution system is expanded.

Individual clients 8 have a storage 85, a registration means which registers a part or all of the storage 85 in a local server 6 as a resource pool, and a requesting means which sends a distribution request for contents to the local server 6. The local server 6 has a storing means which stores a resource pool management table and a content management table, a request accepting means which accepts a distribution request for contents from the individual clients 8, a specifying means which specifies the resource pool storing the contents, a distribution instructing means which sends a distribution instruction for the contents to the client 8 having the specified resource pool.

### BACKGROUND

The present invention relates to a content distribution technique.

In recent years, techniques relating to content distribution networks (CDN), typified by video on demand (VOD) and online karaoke, are developed, and there are various content distribution systems. Particularly, many techniques relating to distributing server load and traffic are developed in content distribution. For example, a distribution video server system is described in Japanese Patent Laid-open Publication No. 9-163353 (hereinafter, referred to as Patent Document 1), in which fragmented pieces of video data placed in a plurality of individual cache servers are modified in arrangement depending on access conditions from clients and load of the cache servers is distributed and leveled.

In the meantime, when the service area of content distribution services is expanded, IT resource facilities forming a system need to be added. For example, as an increase in users (end users) enjoying services, the IT resource facilities of a content distribution system need to be added in a wide range geographically and physically. In addition, Patent Document 1 aims effective utilization of IT resources in existing content distribution systems, but it does not take account of IT resources to be added when the service area is expanded.

### SUMMARY

The present invention has been made in view of the circumstances. An object of the present invention is to suppress the addition of IT resources required for content distribution systems smaller.

In order to solve the problem, the present invention utilizes the storage of a client used by an end user as a content storing region (resource pool) for a content distribution system.

For example, a content distribution system includes a distribution server which instructs distribution of contents and at least one client. Then, the individual clients have a client storage which stores data, a registration means which registers a part or all of the client storage in the distribution server as a resource pool to store the contents, and a requesting means which accepts a distribution request for contents and sends the distribution request for the contents to the distribution server. The distribution server has a distribution server storing means which stores a resource pool management table that manages the resource pool registered by the individual clients, and a content management table that associates the contents with the resource pool storing the contents; a request accepting means which accepts a distribution request for contents from the individual clients; a specifying means which reads out the content management table and specifies the resource pool storing the contents accepted by the request accepting means; and a distribution instructing means which sends a distribution instruction for the contents to a client having the resource pool specified by the specifying means.

The present invention utilizes the storage of the client used by an end user as the content storing region (resource pool) for the content distribution system, and thus can suppress the addition of IT resources smaller.

### BRIEF DESCRIPTION OF THE DRAWINGS

FIG. 1 is an overall block diagram illustrating a system to which an embodiment according to the present invention is applied;

FIG. 2 is a block diagram schematically illustrating a management server and a storage device;

FIG. 3 is a block diagram schematically illustrating a local server;

FIG. 4 is a block diagram schematically illustrating a client;

FIG. 5 is a diagram illustrating an exemplary hardware configuration of individual devices;

FIG. 6 is a diagram illustrating an exemplary content management table;

FIG. 7 is a diagram illustrating an exemplary customer management table;

FIG. 8 is a diagram illustrating an exemplary local server management table;

FIG. 9 is a diagram illustrating an exemplary resource pool management table;

FIG. 10 is a diagram illustrating an exemplary intradomain content management table;

FIG. 11 is a diagram illustrating an exemplary storage management table;

FIG. 12 is a diagram illustrating an exemplary client content management table;

FIG. 13 is a process flow diagram illustrating a resource pool registration process;

FIG. 14 is a diagram schematically illustrating a content distribution process when content exists in a local domain;

FIG. 15 is a diagram schematically illustrating a content distribution process when content is copied;

FIG. 16 is a diagram schematically illustrating a content distribution process when content is transferred;

FIG. 17 is a process flow diagram illustrating a content distribution process;

FIG. 18 is a process flow diagram illustrating the content distribution process;

FIG. 19 is a process flow diagram illustrating the content distribution process; and

FIG. 20 is a process flow diagram illustrating the content distribution process.

### DESCRIPTION OF THE PREFERRED EMBODIMENT

Hereinafter, an embodiment according to the present invention will be described.

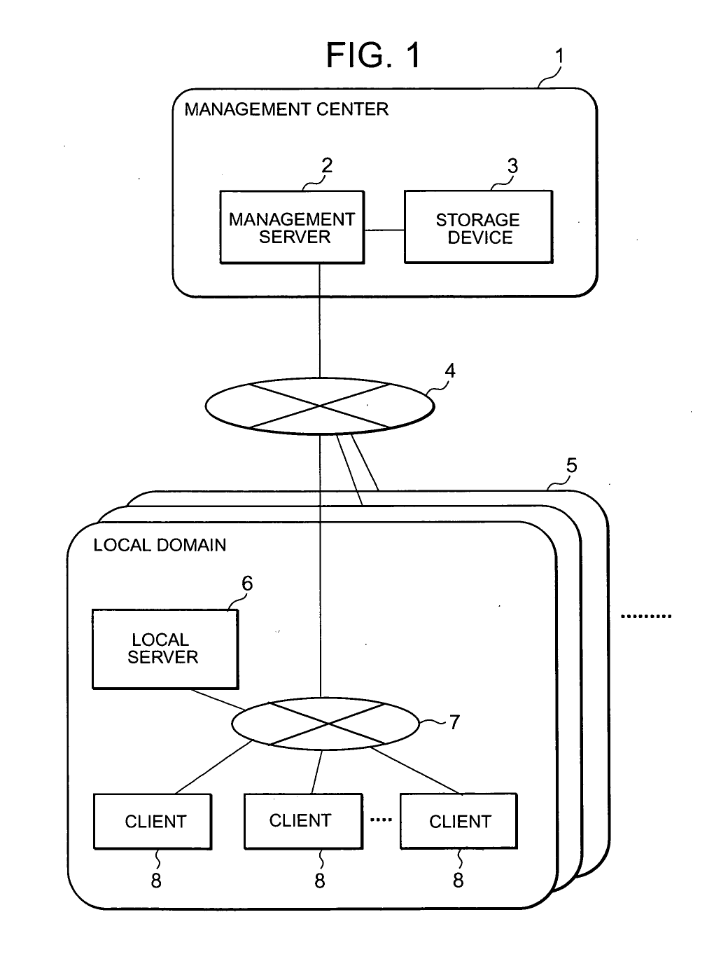

FIG. 1 is an overall block diagram illustrating a content distribution system to which an embodiment according to the present invention is applied. As shown in the drawing, the content distribution system of the embodiment has a management center 1 and at least one local domain 5. Then, the management center 1 has a management server 2 and a storage device 3. The management server 2 is an apparatus that distributes contents stored in the storage device 3 to clients 8 through individual local servers 6. The storage device 3 is an external storage unit of the management server 2, which serves as a repository (warehouse) for contents. Furthermore, the management server 2 is connected to the local server 6 or clients 8 in the individual local domains 5 through an interdomain network 4 such as the Internet 4.

Moreover, contents are information (data) of music, video, images, programs, data bases, and the combination thereof. For exemplary specific contents, there are video data of films and music data for karaoke.

The individual local domains 5 have a local server 6 and at least one client 8. The local server 6 manages individual clients 8 in the local domain 5 to which this local server 6 belongs, and distributes contents to the individual clients 8. The client 8 plays back or reproduces contents stored in the storage of this client 8, or reproduces/plays back contents stored in the storage of the other clients 8, and outputs them to an output control unit. Furthermore, the local server 6 and the individual clients 8 in the local domain 5 are connected to each other by an intradomain network 7. Moreover, the local server 6 and the individual clients 8 in the local domain 5 are connected to the management server 2 and individual devices 6 and 8 in the other local domains 5 through the intradomain network 7 and the interdomain network 4.

The local domain 5 is a given unit (region, area) that manages computers on the network. For example, it can be considered to set the local domain 5 at every country or every prefecture. In addition, it can be considered that an Internet-ready apartment is a single local domain 5. The Internet-ready apartment is an apartment that each room is equipped with facilities to connect to the Internet. Generally in the Internet-ready apartment, a LAN (the intradomain network 7) connected to the Internet is constructed in the apartment, and a modular jack or modular jacks those connects or connect computers, are arranged in each room.

Next, the detail of the management server 2 and the storage device 3 in the management center 1 will be described.

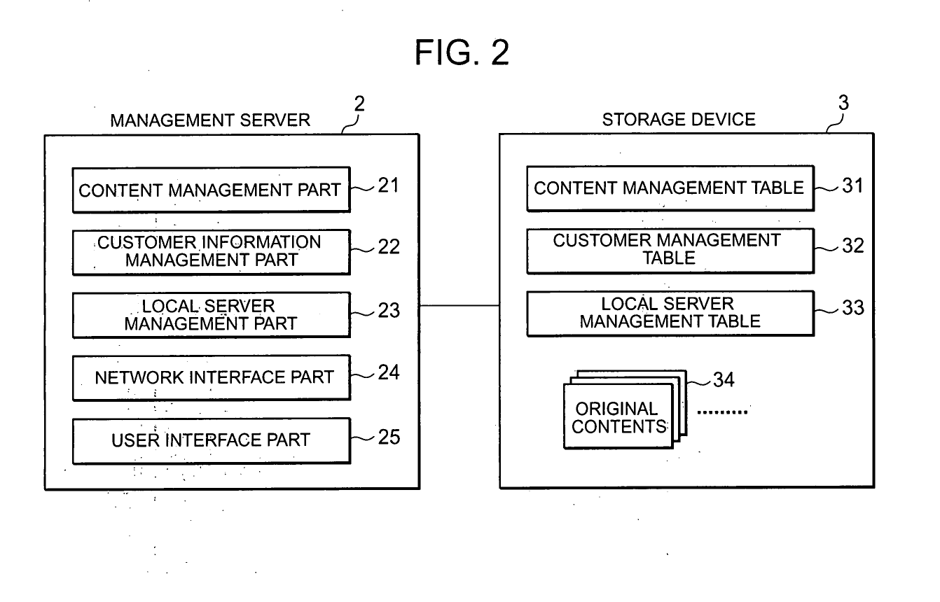

FIG. 2 is a block diagram schematically illustrating the management server 2 and the storage device 3.

As shown in the drawing, the management server 2 has a content management unit 21, a customer information management unit 22, a local server management unit 23, a network interface unit 24, and a user interface unit 25. The content management unit 21 manages a content management table 31 and original contents 34 stored in the storage device 3. The customer information management unit 22 manages a customer management table 32 stored in the storage device 3. The local server management unit 23 manages a local server management table 33 stored in the storage device 3. The network interface unit 24 sends and receives data with external systems such as the local servers 6 through the interdomain network 4 and the intradomain network 7. The user interface unit 25 accepts instructions (operation, input) from a system administrator, and outputs various data to the output control unit.

In the storage device 3, information required for distributing contents by the management server 2 is stored. As shown in the drawing, the storage device 3 has the content management table 31, the customer management table 32, the local server management table 33, and at least one content 34. The contents 34 stored in the storage device 3 are original contents in this content distribution system. The contents 34 are distributed in accordance with a request from the individual clients 8, and stored in the storage of the individual clients 8. In addition, the content management table 31, the customer management table 32, and the local server management table 33 will be described later.

Next, the detail of the local server 6 will be described.

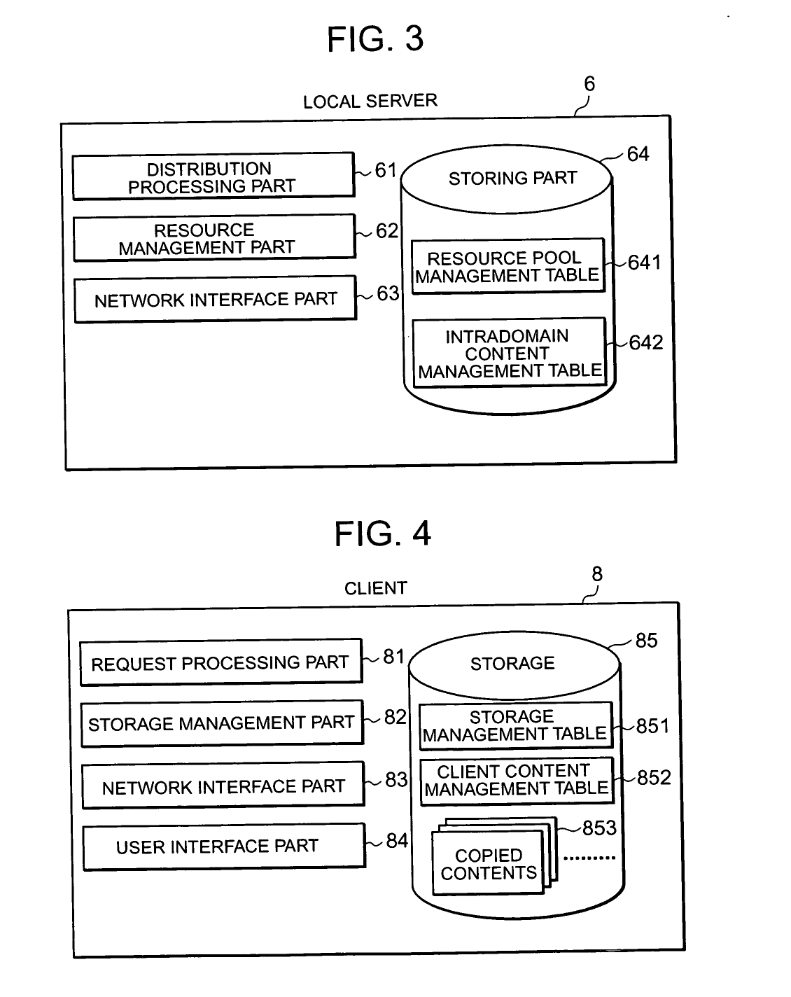

FIG. 3 is a block diagram schematically illustrating a local server 6. As shown in the drawing, the local server 6 has a distribution processing unit 61, are source management unit 62, a network interface unit 63, and a storing unit 64. The distribution processing unit 61 accepts a content distribution request from a client 8, and distributes contents requested to the client 8. The resource management unit 62 manages individual tables 641 and 642 stored in the storing unit 64. The network interface unit 63 sends and receives data with the clients 8 in the same local domain through the intradomain network 7. Furthermore, the network interface unit 63 sends and receives data with the management server 2, or individual devices 6 and 8 in the other local domains 5 through the intradomain network 7 and the interdomain network 4. The storing unit 64 has a resource pool management table 641 and an intradomain content management table 642, which will be described later.

Next, the detail of the client 8 will be described.

FIG. 4 is a block diagram schematically illustrating a client 8. As shown in the drawing, the client 8 has a request processing unit 81, a storage management unit 82, a network interface unit 83, a user interface unit 84, and a storage 85. The request processing unit 81 accepts a content distribution request inputted through the user interface unit 84, and requests the local server 6 for contents. The storage management unit 82 manages individual tables 851 and 852 and contents 853 stored in the storage 85. The network interface unit 83 sends and receives data with the local server 6 and the other clients 8 in the same local domain 5 through the intradomain network 7. Furthermore, the network interface unit 83 sends and receives data with the management server 2 and the individual devices 6 and 8 in the other local domains 5 through the intradomain network 7 and the interdomain network 4. The user interface unit 84 accepts instructions (operation, input) by a user who uses this client, and outputs various data to the output control unit.

The storage 85 is a storage unit that stores various data. In the embodiment, the individual clients 8 register (provide) a part or all of the storage 85 held by this client 8 in the local server 6 as a resource pool (content storing region) that stores contents. A part or all of the storage 85 is registered as the resource pool, and thus the individual clients 8 can request content distribution and can reproduce or play back the distributed contents.

The storage 85 has a storage management table 851, a client content management table 852 and contents 853 in the area registered as the resource pool. The contents 853 stored in the storage 85 in the client 8 are copies of the original contents 34 stored in the storage device 3 in the management center 1. Moreover, the storage management table 851 and the client content management table 852 will be described later. In addition, in the storage 85, various data (not shown) specific to the owner client 8 is stored in the region other than the resource pool.

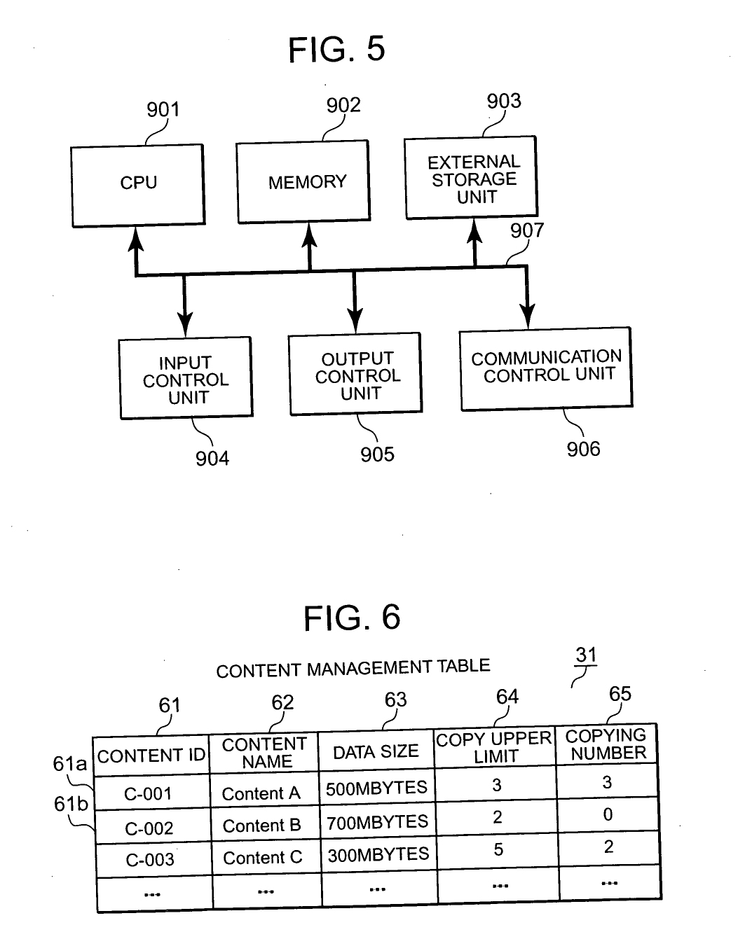

The management server 2, the local server 6, and the client 8 described above can all use a general computer system having a CPU 901, a memory 902, an external storage unit 903 such as HDD, an input control unit 904 such as a keyboard and a mouse, an output control unit 905 such as a display and a printer, a communication control unit 906 which connects to networks, and a bus 907 which connects individual devices, as shown in FIG. 5, for example. In this computer system, the CPU 901 executes given programs loaded on the memory 902, and thus the functions of the individual devices are implemented. For example, the individual functions of the management server 2, the local server 6, and the client 8 are implemented by the CPU 901 of the management server 2 to execute programs for the management server 2, by the CPU 901 of the local server 6 to execute programs for the local server 6, and by the CPU 901 of the client 8 to execute programs for the client 8.

In addition, the storage device 3 in the management center 1 is used as the external storage unit 903 or the memory 902 for the management server 2. Furthermore, for the storing unit 64 in the local server 6, the memory 902 or the external storage unit 903 in the local server 6 is used. Moreover, for the storage 85 in the client 8, the memory 902 or the external storage unit 903 in the client 8 is used.

Next, the individual tables stored in the storage device 3 in the management server 1 will be described.

FIG. 6 is a diagram illustrating an exemplary content management table 31. The content management table 31 has a content ID 61, a content name 62, a data size 63, a copy upper limit 64, and a copying number 65 for each of the contents. The content ID 61 is identification information that identifies individual contents. The content name 62 is a name of contents. The data size 63 is the data size of contents. The copy upper limit 64 is the maximum number that contents can be copied (that is, distributable) to the client 8 in the local domain 5. The copying number 65 is the number of times that contents have been copied (distributed) to the client 8 in the local domain 5. For example, one of contents with ‘C-001’ 61a for the content ID 61 has ‘Content A’ for the content name 62, ‘500 Mbytes’ for the data size 63, ‘3’ for the copy upper limit 64, and ‘3’ for the copying number 65.

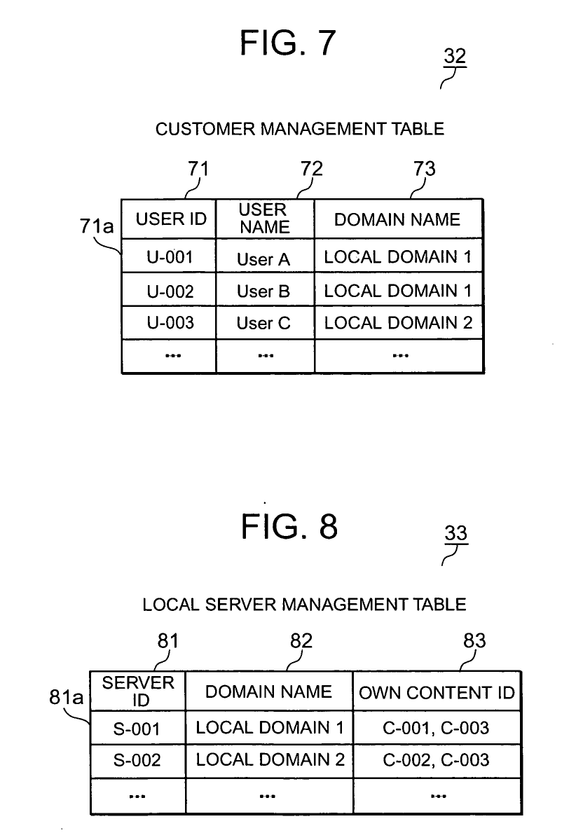

FIG. 7 is a diagram illustrating an exemplary customer management table 32. The customer management table 32 has a user ID 71, a user name 72, and a belonging domain name 73 for each of the customers. The user ID 71 is identification information that identifies individual users. The user name 72 is the name of a user. The belonging domain name 73 is the name or identification information of the local domain 5 to which the user (that is, the client 8 used by this user) belongs. For example, a user with ‘U-001’ 71a for the user ID 71 has ‘User A’ for the user name 72, and ‘local domain 1’ for the belonging domain name 73.

FIG. 8 is a diagram illustrating an exemplary local server management table 33. The local server management table 33 has a server ID 81, a belonging domain name 82, and an own content ID 83 for each of the local servers 6. The server ID 81 is identification information that identifies the local servers 6. The belonging domain name 82 is the name or identification information of local domains to which individual local servers 2 belong. To the own content ID 83, content IDs of individual contents existing in the corresponding local domain are set individually. More specifically, the content IDs of contents stored (copied) in each of the resource pools of the individual clients 8 in this local domain are set to the own content ID 83.

In the example shown in the drawing, a local server 6 with ‘S-001’ 81a for the server ID 81 has ‘local domain 1’ for the belonging domain name 82, and ‘C-001’ and ‘C-003’ for the own content ID 83 existing in the local domain 1.

Next, the individual tables stored in the storing unit 64 in the local server 6 will be described.

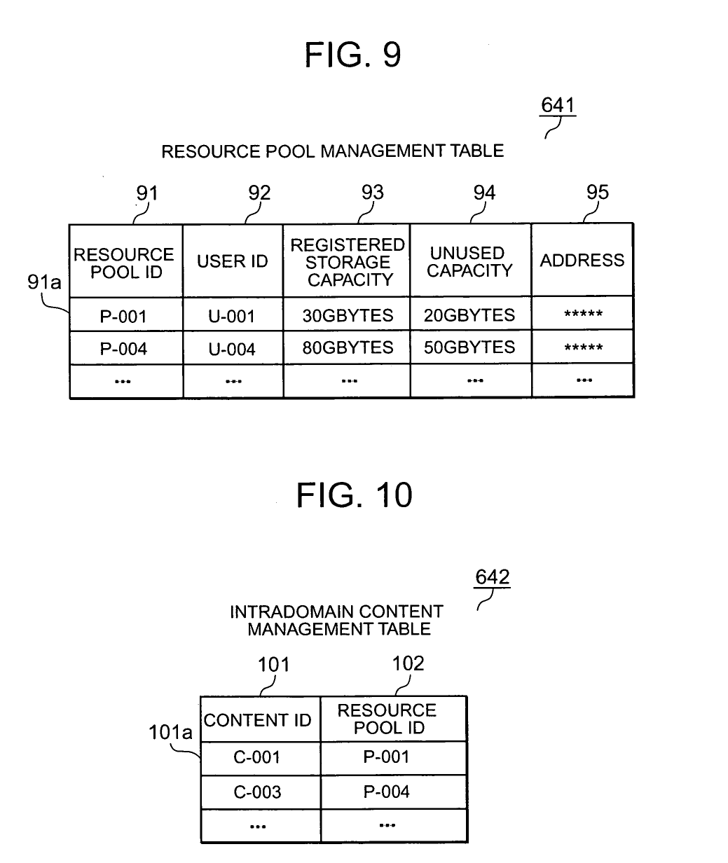

FIG. 9 is a diagram illustrating an exemplary resource pool management table 641. The resource pool management table 641 is a table that manages resource pools registered by the individual clients 8 in the local domain. The resource pool management table 641 has a resource pool ID 91, a user ID 92, a registered storage capacity 93, an unused capacity 94, and an address 95 for each of the resource pools. The resource pool ID 91 is identification information that identifies the individual storages 85 in the clients 8 registered as resource pools. The user ID 92 is identification information that identifies a user. To the user ID 92, the user ID of a user who uses a client 8 having this resource pool (storage 85) is set. The registered storage capacity 93 is the capacity of a storage registered as a resource pool. The unused capacity 94 is the capacity of a storage that is not used in the registered storage capacity 93.

The address 95 is location information of a resource pool. More specifically, the address 95 includes the address (for example, an IP address and a DNS name) of a client 8 on the network, and a location of a resource pool in this client 8. The local server 6 uses the address 95, and thus can make access to a resource pool transparently. For example, the address 95 can be implemented by using the iSCSI technology or technique of IP-SAN. In addition, the address 95 may be dynamically set by a DHCP (Dynamic Host Configuration Protocol) server. Furthermore, the local server 6 may set a predetermined address 95 to each of the clients 8.

In the example shown in the drawing, a resource pool with ‘P-001’ 91a for the resource pool ID 91 has ‘U-001’ for the user ID 92, ‘30 Gbytes’ for the registered storage capacity 93, and ‘20 Gbytes’ for the unused storage capacity 94.

FIG. 10 is a diagram illustrating an exemplary intradomain content management table 642. The intradomain content management table 642 is a table that shows which resource pool stores the individual contents existing in the local domain. The intradomain content management table 642 has a content ID 101, and a resource pool ID 102 in which the content of this content ID 101 is stored. In the example shown in the drawing, a content with ‘C-001’ 101a for the content ID 101 is stored in a resource pool having ‘P-001’ for the resource pool ID 102.

Next, the individual tables stored in the storage 85 in the client 8 will be described.

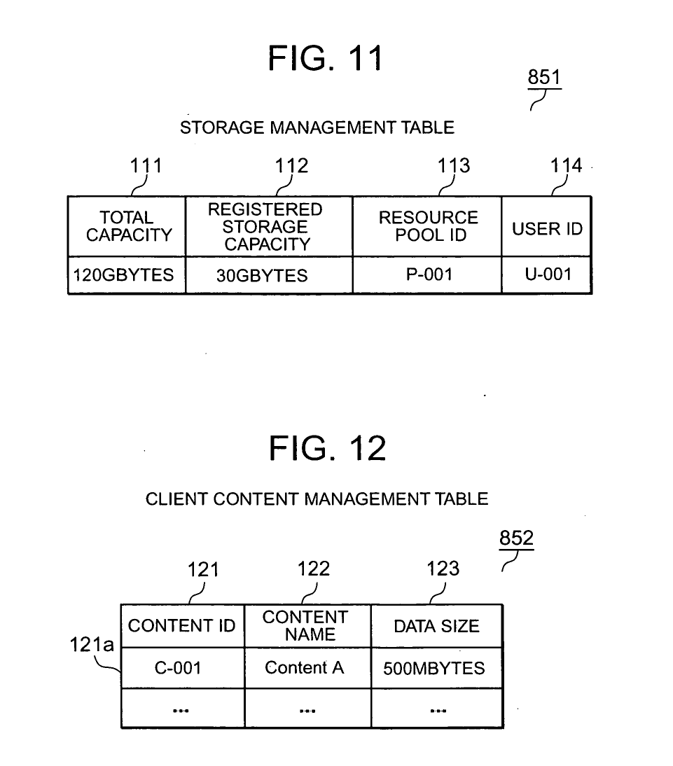

FIG. 11 is a diagram illustrating an exemplary storage management table 851. The storage management table 851 is a table that stores information about a storage 85. The storage management table 851 has a total capacity 111, a registered storage capacity 112, a resource pool ID 113, and a user ID 114. The total capacity 111 is the total storage capacity of the storage 85. The registered storage capacity 112 is the storage capacity registered as a resource pool in the total capacity 111. The resource pool ID 113 is identification information of the resource pool of this client 8. The user ID 114 is identification information for a user who uses this client 8. In the example shown in the drawing, the total capacity 111 of the storage 85 is ‘120 Gbytes’, the registered storage capacity 112 is ‘30 Gbytes’, the resource pool ID 113 is ‘P-001’, and the user ID 114 is ‘U-001’.

FIG. 12 is a diagram illustrating an exemplary client content management table 852. The client content management table 852 is a table that manages contents stored in the resource pool in the individual clients 8. The client content management table 852 has a content ID 121, a content name 122, and a data size 123 for each of the contents. The content ID 121, the content name 122, and the data size 123 are the same as the content ID 61, the content name 62, and the data size 63 of the content management table 31 shown in FIG. 6. In the example shown in the drawing, one of contents is stored in a resource pool, which has ‘C-001’ 121a for the content ID 121, ‘Content A’ for the content name 122, and ‘500 Mbytes’ for the data size 123.

Next, a process will be described that a part or all of a storage 85 is registered as a resource pool in a local server 6. A client 8 registers a part or all of the storage 85 thereof in the local server 6 in the same local domain 5 as the resource pool, and thus the individual clients 8 can receive the distribution of contents provided by the content distribution system. More specifically, a local server 6 accepts the registration of the resource pool from the individual clients 8 in the local domain 5 to which this local server 6 belongs, and manages each of the resource pool in a centralization manner. Then, the local server 6 copies (alternatively, transfers) the contents stored in the storage device 3 in the management center 1 (or the resource pool in the other local domains 5) to each of the accepted resource pools. More specifically, each of the resource pools registered in the local server 6 is a shared content storing region where contents are distributed to the individual clients 8 in that local domain 5.

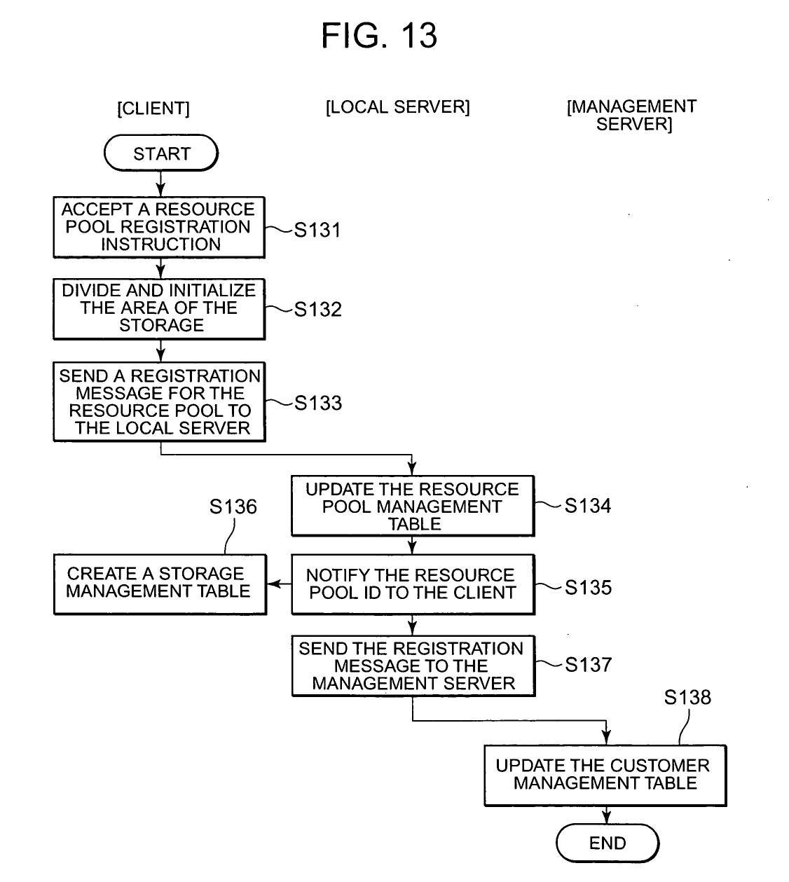

FIG. 13 is a process flow of are source pool registration process in which a resource pool is registered in the local server 6. First, the storage management unit 82 in the client 8 accepts a resource pool registration instruction inputted through the user interface unit 84 (S131). A user uses the input control unit 904 to input an instruction that registers a part or all of the capacity of the storage 85 in the client 8 of this user as a resource pool.

Subsequently, the storage management unit 82 divides (that is, partitions) the area of the instructed capacity from the storage area of the storage 85 as an area for the resource pool based on the accepted registration instruction (S132). Then, the storage management unit 82 initializes the area divided for the resource pool in a predetermined format. Therefore, the local server 6 can recognize the area divided for the resource pool (hereinafter, ‘partition’).

After that, the storage management unit 82 sends a registration message for the initialized partition to the local server 6 through the intradomain network 7 (S133). In addition, the registration message includes a registered storage capacity and a predetermined user ID of the user to use this client inputted through the user interface unit 84.

Subsequently, the resource management unit 62 in the local server 6 receives the registration message from the client 8, and registers the data of the registration message in the resource pool management table 641 (see FIG. 9) (S134) More specifically, the resource management unit 62 specifies a unique (unused) resource pool ID. Furthermore, the resource management unit 62 specifies the addresses of the resource pools dynamically set by a DHCP server, or the address of the resource pool predetermined at each of the clients 8. Then, the resource management unit 62 adds a record to which the specified resource pool ID 91, the user ID 92 and the registered storage capacity 93 contained in the registration message and the specified address 95 are set to the resource pool management table 641. Moreover, at this point in time, the same capacity as the registered storage capacity 93 contained in the registration message is set to the unused capacity 94.

Subsequently, the resource management unit 62 sends the resource pool ID 91 set to the resource pool management table 641 to the client 8 through the intradomain network 7 (S135). The storage management unit 82 in the client 8 creates (or updates) the storage management table 851 in the storage 85 (S136). More specifically, the storage management unit 82 sets the predetermined capacity to the total capacity 111, the capacity accepted at S131 to the registered storage capacity 112, the resource pool ID notified at S135 to the resource pool ID 113, and the predetermined user ID to the user ID 114.

After that, the resource management unit 62 in the local server 6 sends the registration message to the management server 2 through the intradomain network 7 and the interdomain network 4 (S137). In addition, in the registration message includes the user ID 92 set to the resource pool management table 641 and the name of the local domain to which the local server 6 belongs. Furthermore, the resource management unit 62 is considered to store the name of the local domain to which the local server 6 belongs in the storing unit 64 beforehand.

The customer information management unit 22 in the management server 2 accepts the registration message from the local server 6, and updates the customer management table 32 (see FIG. 7) (S138). More specifically, the customer information management unit 22 specifies the user name matching with the user ID contained in the registration message from a user ID matching table, not shown, stored in the storage device 3. Then, the customer information management unit 22 adds a record to which the user ID 71 and the belonging domain name 73 contained in the registration message and the specified user name 72 are set to the customer management table 32.

By the resource pool registration process described above, the client 8 that has registered the resource pool can be provided with the content distribution service.

Next, a content distribution process will be described.

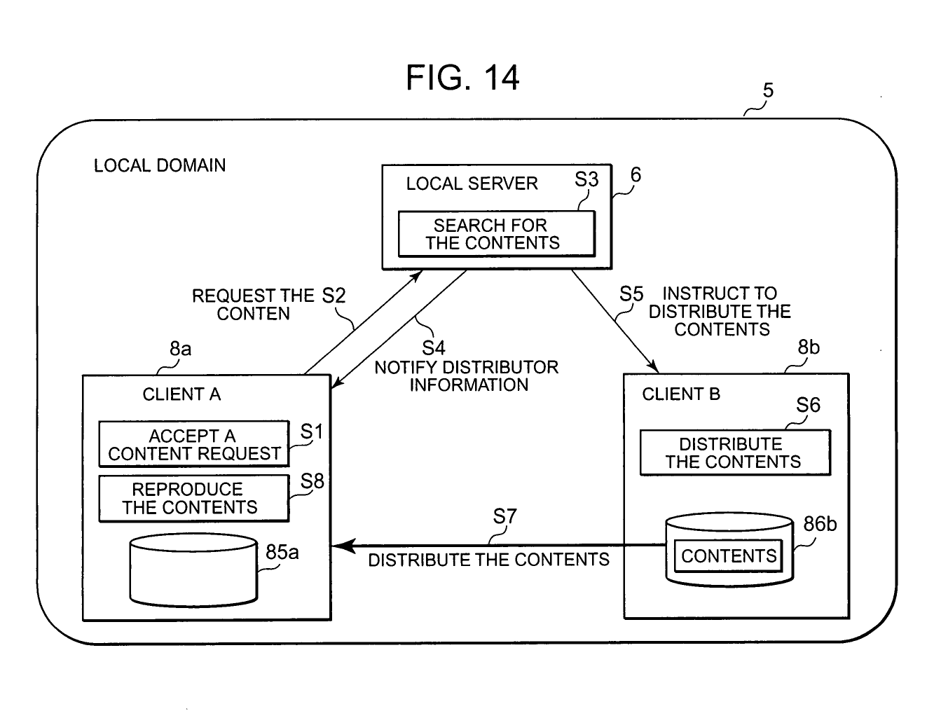

FIG. 14 is a diagram schematically illustrating a content distribution process when requested contents exist in the same local domain 5. In the example shown in the drawing, an example will be described below that a client A 8a belonging to a given local domain 5 requests contents stored in a client B 8b belonging to in the same local domain. In addition, the local domain 5 shown is considered to have a local server 6, the requester client A 8a to request the contents, and the distributor client B 8b to distribute the contents.

First, the client A 8a accepts a request for contents inputted from the input control unit 904 (S1), and sends a content request message to the local server 6 (S2). Then, the local server 2 receives the content request message, refers to the intradomain content management table 642 (see FIG. 10), and searches for the stored location of the contents requested by this message (S3). In addition, in the example shown in the drawing, the requested contents are considered to be stored in the storage 85b (resource pool) in the client B 8b. Then, the local server 6 notifies the client A 8a about the distributor client (the client B 8b) that distributes the requested content (S4). Furthermore, the local server 6 instructs the client B 8b to distribute the requested contents to the requestor client (the client A 8a) (S5).

Subsequently, the client B 8b reads the requested contents out of the storage 85b (resource pool), and distributes them to the client A 8a (S6 and S7). The client A8a receives the contents from the client B 8b, and reproduces or executes and outputs the contents to the output control unit 905 (S8). More specifically, the client A 8a reproduces or executes the received contents by streaming without storing them in the storage 85a.

By the content distribution process described above, the client A 8a receives the requested contents from the client B 8b for reproduction. Thus, the user using the client A 8a can enjoy the contents outputted to the output control unit 905. In this case, since the client B 8b and the client A 8a belong to the same local domain 5, the client A 8a does not store the received contents in the storage 85a. In this manner, contents stored in the storage 85 (resource pool) in any clients 8 in the same the local domain 5 are distributed to the client 8 in the same the local domain through the intradomain network 7. In addition, the intradomain network 7 has smaller network traffic and a greater network bandwidth for content distribution than the interdomain network 4 has. Therefore, the client 8 on the distributor side can distribute contents with a large volume of data such as video and music at a constant transmission speed through the intradomain network 7. Furthermore, the client 8 on the receiver side can reproduce the received contents by streaming.

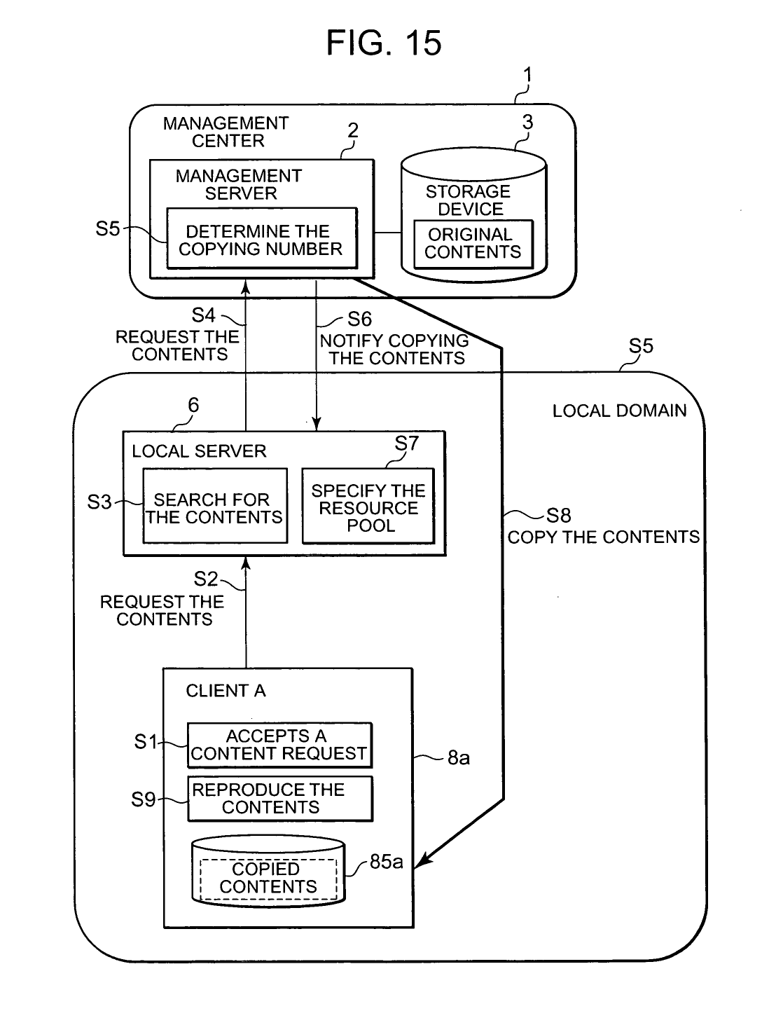

FIG. 15 is a diagram schematically illustrating a content distribution process when requested contents do not exist in the same local domain 5 and the copying number of the contents has not reached the upper limit. In the example shown in the drawing, an example will be described below that a client A 8a belonging to a given local domain requests contents not existing in the same the local domain 5.

First, the client A 8a accepts a request for contents inputted from the input control unit 904 (S1), and sends a content request message to the local server 6 (S2). Then, the local server 6 receives the content request message from the client A 8a, refers to the intradomain content management table 642 (see FIG. 10), and searches for the stored location of the contents requested by this request message (S3). In the example shown in the drawing, the requested contents are considered not to be stored in any storages 85 (resource pools) in the individual clients 8 in the local domain. Therefore, the local server 6 requests the management server 2 for the contents (S4).

The management server 2 refers to the content management table 31 (see FIG. 6) stored in the storage device 3, and determines whether the copying number of the requested contents has reached the upper limit (S5). In the example shown in the drawing, the copying number of the requested contents is considered not to have reached the upper limit. Thus, the management server 2 notifies the local server 6 that the requested contents are to be copied from the storage device 3 (S6).

The local server 6 refers to the unused capacity 94 in the resource pool management table 641 (see FIG. 9), and specifies the resource pool to store the contents for copying (S7). In the example shown in the drawing, the local server 6 is considered to specify the storage 85a in the client A 8a as the resource pool. Subsequently, the management server 2 reads the contents out of the storage device 3, and copies (distributes) them to the resource pool specified by the local server 6 (S8). The client A 8a receives the contents from the management server 2, and stores the contents in the storage 85a as well as reproduces and outputs the contents to the output control unit 905 (S9). More specifically, the client A 8a performs streaming the received contents.

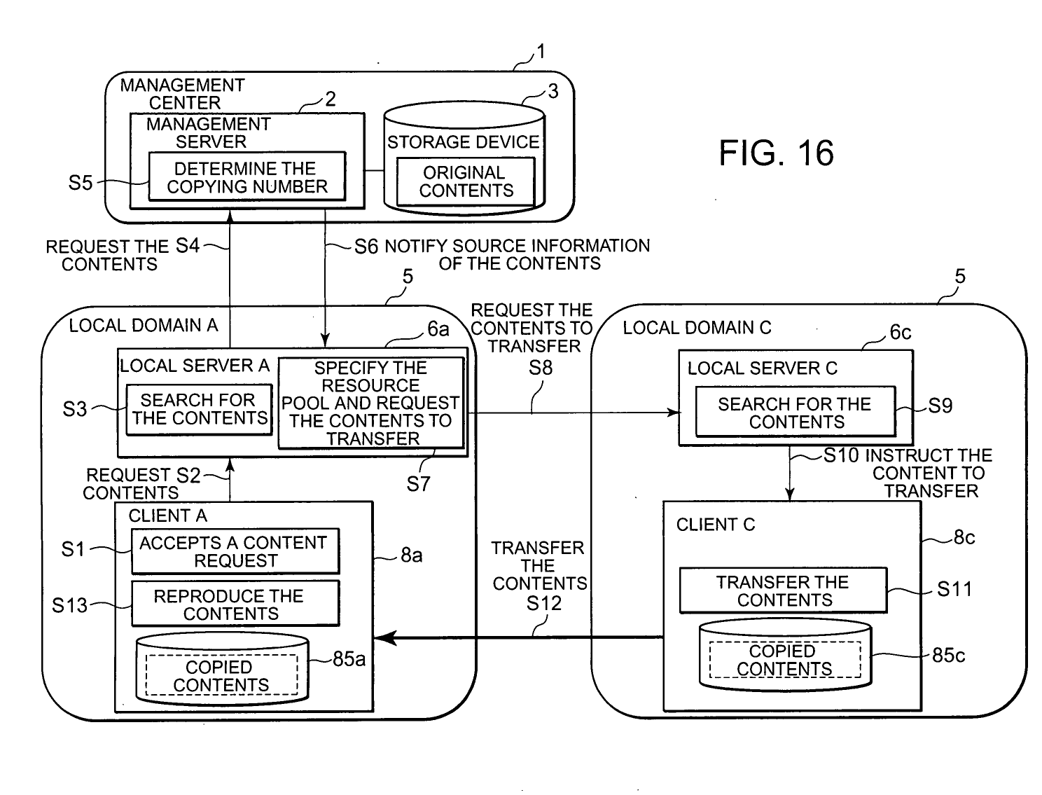

FIG. 16 is a diagram schematically illustrating a content distribution process when requested contents do not exist in the same local domain 5 and the copying number of the contents has reached the upper limit. More specifically, an example will be described below that a requestor client A 8a having requested contents transfers the contents from a source client C 8c in a local domain C different from a local domain A. In addition, the process from S1 to S4 is the same as the process from S1 to S4 described in FIG. 15, thus omitting the description here.

The management server 2 having accepted a request for contents from a local server A 6a in the local domain A refers to the content management table stored in the storage device 3, and determines whether the copying number of the requested contents has reached the upper limit (S5). In the example shown in the drawing, the copying number of the requested contents is considered to have reached the upper limit. Therefore, the management server 2 cannot further copy the requested contents from the storage device 3. Thus, the management server 2 refers to the local server management table 33 (see FIG. 8), specifies the local server 6 (source local server) that owns the requested contents, and notifies the local server A 6a of information about the specified source local server (S6). In the example shown in the drawing, the source local server is considered to be a local server C 6c in the local domain C.

The local server A 6a in the local domain A refers to the unused capacity 94 in the resource pool management table 664 (see FIG. 9), and specifies the resource pool to be the destination of the contents (S7). In the example shown in the drawing, the local server A 6a is considered to specify the resource pool of the storage 85a in the client A 8a. Furthermore, the local server A 6a sends a content transfer request message that requests the local server C 6c to transfer the contents, which is the source local server notified by the management center 2 (S7 and S8).

The local server C 6c in the local domain C receives the content transfer request message, refers to the intradomain content management table 642 (see FIG. 10.), and searches for the stored location of the contents requested by the request message (S9). Then, the local server C 6c instructs the client C 8c storing contents to transfer the contents to the resource pool in the client A 8a (S10). The client C 8c transfers (distributes) the contents to the resource pool in the client A 8a (S11 and S12). Moreover, when the contents are transferred, the client C 8c deletes the contents from the storage 85c after it distributes the contents. The client A 8a stores the received contents in the resource pool in the storage 85a, and reproduces and outputs them to the output control unit 905 (S13). More specifically, the client A 8a performs streaming the received contents.

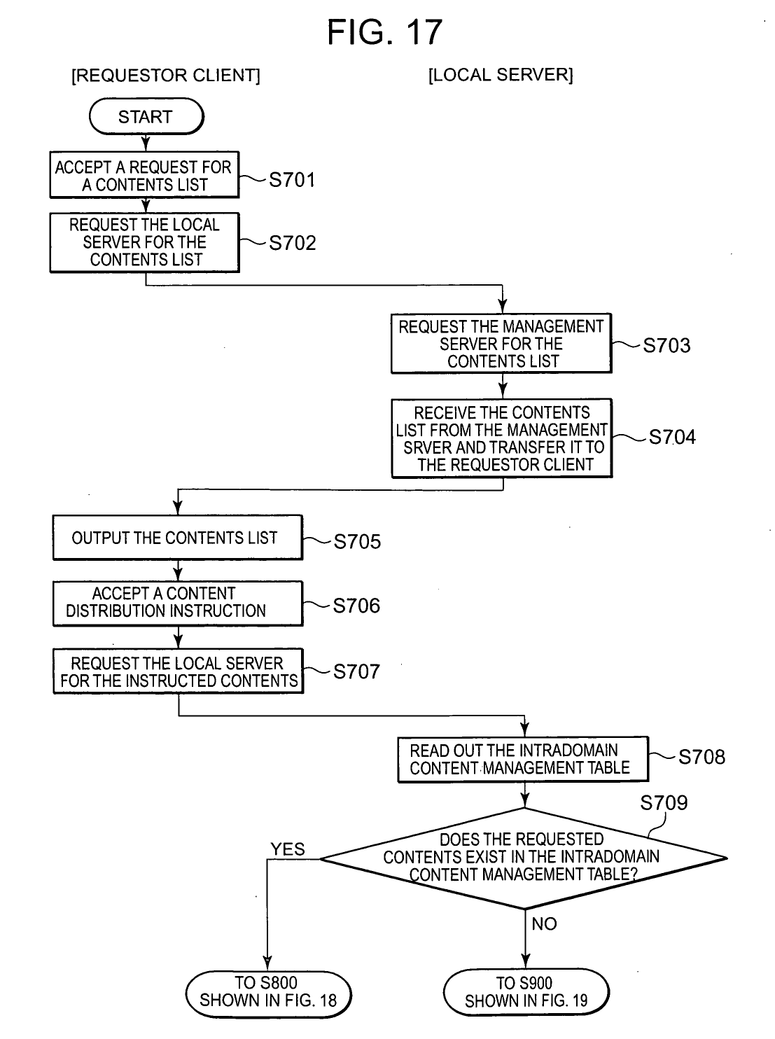

The content distribution processes shown in FIGS. 14 to 16 will be described in detail with process flows shown in FIGS. 17 to 20.

FIG. 17 is a process flow that the client 8 first accepts an instruction and then the local server 6 determines whether the requested contents exist in the local domain 5.

First, the request processing unit 81 in the client 8 accepts a request for a contents list through the user interface unit 84 (S701). More specifically, a user using this client 8 inputs a request instruction for the contents list with the input control unit 904. The contents list is a list of the content IDs and the content names for all the contents 34 stored in the storage device 3 in the management center 1. Then, the request processing unit 81 requests the local server 6 for the contents list through the intradomain network 7 (S702).

When the distribution processing unit 61 in the local server 6 receives the request for the contents list from the client 8, it requests the management server 2 for the contents list through the intradomain network 7 and the interdomain network 4 (S703). When the content management unit 21 in the management server 2 receives the request for the contents list, it reads out the content management table 31 (see FIG. 6) stored in the storage device 3. Subsequently, the content management unit 21 creates and sends a contents list showing the content IDs 61 and the content names 62 for all the records in the content management table 31 to the local server 6.

When the distribution processing unit 61 in the local server 6 receives the contents list from the management server 2, it transfers the contents list to the requestor client 6 through the intradomain network 7 (S704).

When the request processing unit 81 in the client 8 receives the contents list, it outputs the received contents list to the output control unit 905 with the user interface unit 84 (S705).

Subsequently, the request processing unit 81 accepts a distribution instruction for the contents inputted through the user interface unit 84 (S706). More specifically, the user uses the input control unit 904 to tell the contents requested for distribution in the contents list outputted to the output control unit 905 of the client 8. Then, the request processing unit 81 sends a distribution request message for the instructed contents to the local server 6 through the intradomain network 7 (S707). In addition, the distribution request message includes the content ID of the specified contents and the user ID of the user who uses the client 8.

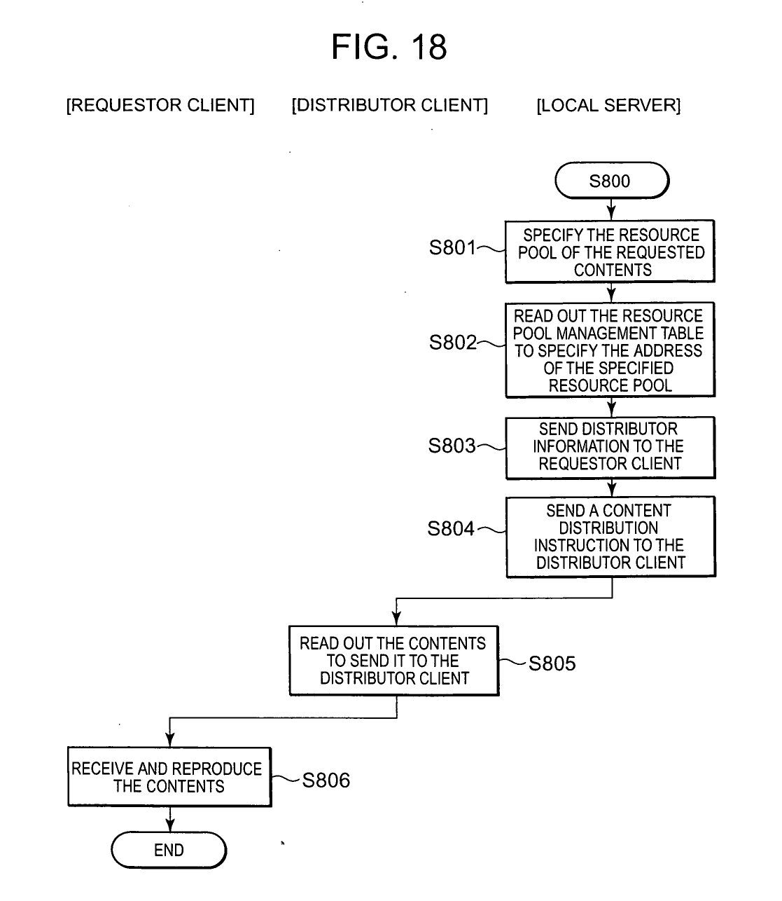

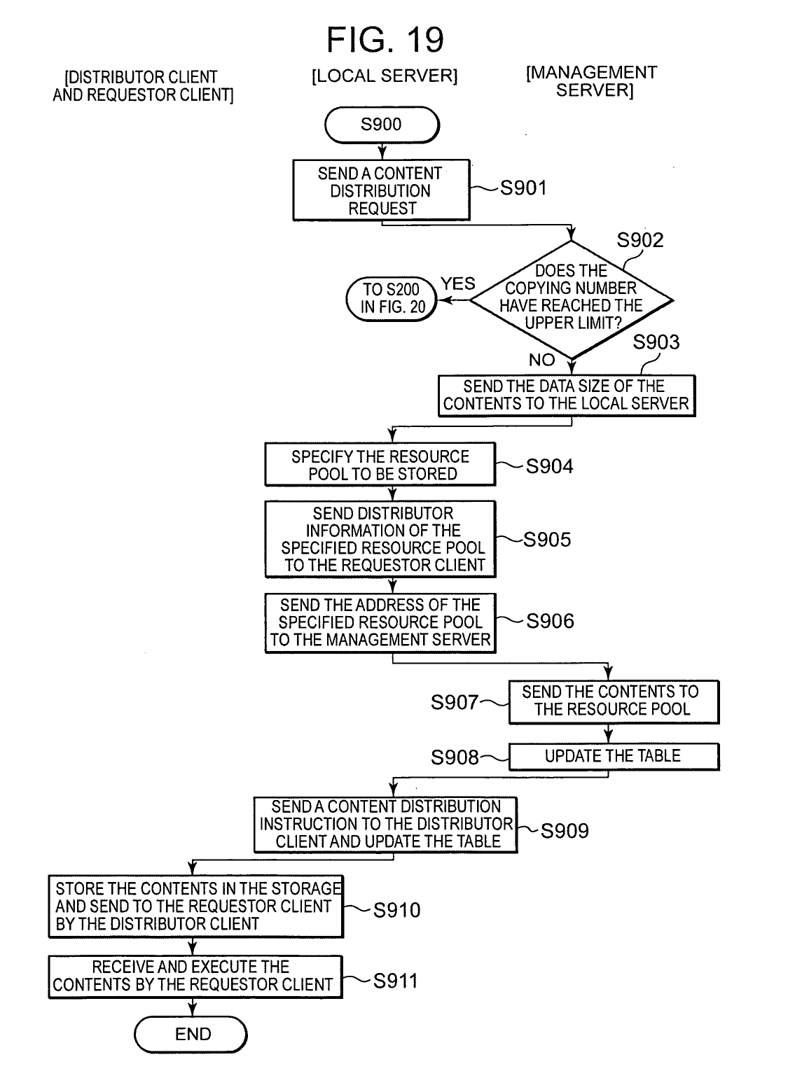

Then, the distribution processing unit 61 in the local server 6 accepts the distribution request message from the client 8, and reads out the intradomain content management table 642 stored in the storing unit 64 (S708). After that, the distribution processing unit 61 determines whether the content ID included in the distribution request message exists in the intradomain content management table 642 (S709) More specifically, the distribution processing unit 61 determines whether the requested contents exist in the resource pool in the local domain 5. When the requested content ID exists in the intradomain content management table 642 (S709: YES), the distribution processing unit 61 proceeds to the process in S800, which will be described in FIG. 18. On the other hand, when the requested content ID does not exist in the intradomain content management table 642 (S709: NO), the distribution processing unit 61 proceeds to the process in S900, which will be described in FIG. 19.

FIG. 18 is a process flow when the requested content ID exists in the intradomain content management table 642 (S709: YES in FIG. 17).

The distribution processing unit 61 in the local server 6 refers to the intradomain content management table 642, and specifies the resource pool ID matching with the requested content ID requested at S707 in FIG. 17 (S801). Then, the distribution processing unit 61 reads out the resource pool management table 641 (see FIG. 9), and specifies the address 95 of the specified resource pool ID (S802). Subsequently, the distribution processing unit 61 sends distributor information including the specified address 95 to the requestor client 8 through the interdomain network 7 (S803). Furthermore, the distribution processing unit 61 sends a content distribution instruction to the client having the resource pool storing the requested contents (hereinafter, the ‘distributor client’) through the interdomain network 7 as the specified address 95 is the destination (S804). Moreover, the content distribution instruction includes the requested content ID and the address of the requestor client 8. It is acceptable that the distribution processing unit 61 specifies the address 95 matching with the user ID contained in the distribution request message having been sent at S707 in FIG. 17 from the resource pool management table 641, and the address is included in the content distribution instruction as the destination of the requester client 8.

The request processing unit 81 in the distributor client 8 reads out the contents having the requested content ID contained in the content distribution instruction among a plurality of contents stored in the resource pool of the storage 85. Then, the request processing unit 81 distributes the contents read out to the requestor client through the network interface unit 83, in the data form that the contents can be reproduced and outputted to the output control unit in the client (S805).

More specifically, the request processing unit 81 distributes the requested contents through the intradomain network 7 as the address of the requestor client 8 specified in the content distribution instruction is the destination.

The request processing unit 81 in the requester client 8 receives the contents from the distributor client 8, and reproduces and outputs the contents to the output control unit 905 (S806). More specifically, the request processing unit 81 in the requestor client 8 reproduces the received contents by streaming without storing them in the storage 85.

FIG. 19 is a process flow when the requested content ID does not exist in the intradomain content management table 642 (S709: NO in FIG. 17).

The distribution processing unit 61 in the local server 6 sends a content distribution request to the management server 2 through the intradomain network 7 and the interdomain network 4 (S901). In addition, the content distribution request includes the content ID sent at S707 in FIG. 17.

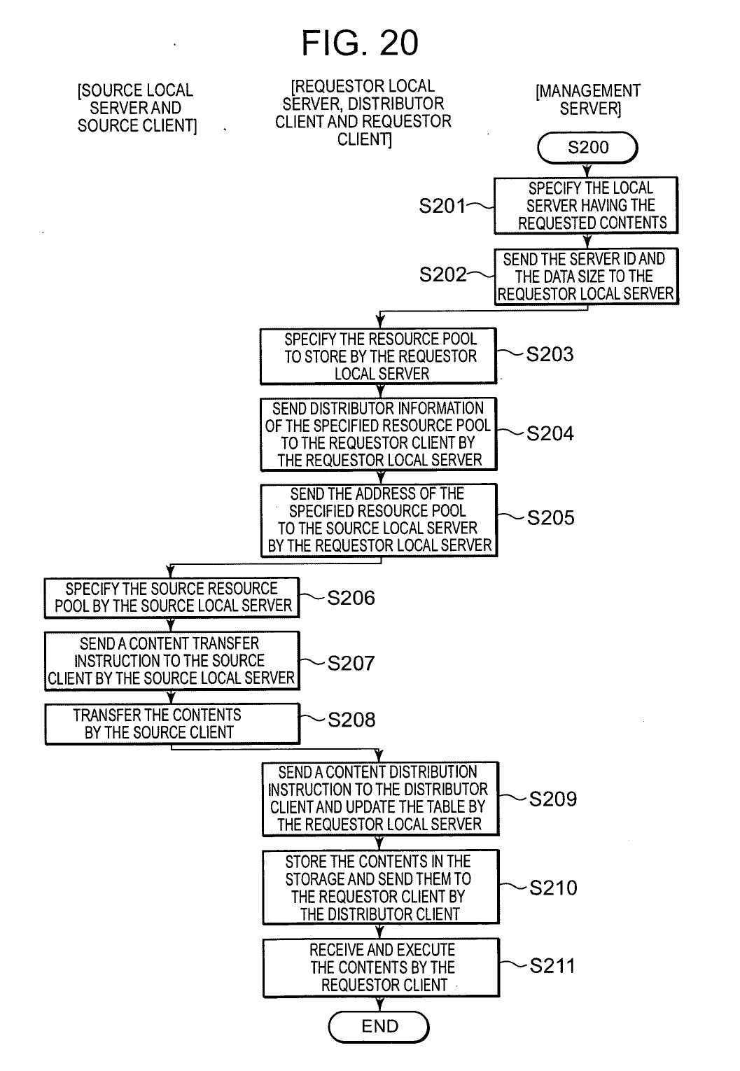

Then, the content management unit 21 in the management server 2 accepts the content distribution request, and determines whether the copying number of the content ID included in the content distribution request has reached the upper limit (S902). More specifically, the content management unit 21 reads out the content management table 31, and specifies the copy upper limit 64 and the copying number 65 of the content ID. Subsequently, the content management unit 21 determines that the copying number has reached the upper limit when the numeric value of the copy upper limit 64 is the same as the numeric value of the copying number 65. In the case of the content management table 31 shown in FIG. 6, the copy upper limit 64 of the content ID with ‘C-001’ 61a and the copying number 65 are both ‘three’. Therefore, in the case of the contents having the content ID of ‘C-001’ 61a, the content management unit 21 determines that the copying number has reached the upper limit. The process when the copying number has reached the upper limit (S902: YES) will be described later in FIG. 20.

On the other hand, when the numeric value of the copy upper limit 64 is smaller than the numeric value of the copying number 65, the content management unit 21 determines that the copying number has not reached the upper limit. In the case of the content management table shown in FIG. 6, the copy upper limit is ‘two’ and the copying number is ‘zero’ for the content ID of ‘C-002’ 61b. Thus, in the case of the contents with the content ID of ‘C-002’ 61b, the content management unit 21 determines that the copying number has not reached the upper limit.

When the copying number has not reached the upper limit (S902: NO), the content management unit 21 sends the data size 63 of the content ID stored in the content management table 31 to the local server 6 (S903). The distribution processing unit 61 in the local server 6 receives the data size of the contents, and specifies the resource pool ID to store the contents based on the received data size (S904) More specifically, the distribution processing unit 61 refers to the resource pool management table 641, and specifies the resource pool ID 91 greater than the data size received in the unused capacity 94. Furthermore, when there are multiple resource pools of the unused capacity 94 greater than the received data size, the distribution processing unit 61 specifies the resource pool according to given rules such as the resource pool ID with the smallest resource pool ID to be specified. Subsequently, the distribution processing unit 61 sends distributor information including the address 95 of the specified resource pool ID 91 to the requestor client 8 through the intradomain network 7 (S905). Moreover, the distribution processing unit 61 sends the address 95 of the specified resource pool ID 91 to the management server 2 through the intradomain network 7 and the interdomain network 4 (S906).

The content management unit 21 in the management server 2 reads the requested contents out of the storage device 3, and distributes (copies) the contents read out to the resource pool of the sent address (S907). In addition, the content management unit 21 sends the content ID 61, the content name 62, and the data size 63 of the contents stored in the content management table 31 to the resource pool of the address along with the contents. Then, the content management unit 21 updates the content management table 31 (S908). More specifically, the content management unit 21 adds ‘one’ to the copying number 65 of the contents ID 61 distributed. Furthermore, the local server management unit 23 updates the local server management table 33 (S908). More specifically, the local server management unit 23 adds the distributed content ID to the content ID 83 matching with the server ID 81 of the requester local server 6.

The distribution processing unit 61 in the local server 6 instructs the client 8 of the resource pool ID specified at S904 (hereinafter, ‘the distributor client’) to distribute the contents having been distributed from the management server 2 (S909). Moreover, the content distribution instruction includes the requested content ID and the address of the requester client 8.

In addition, the resource management unit 62 in the local server 6 updates the resource pool management table 641 and the intradomain content management table 642 (S909). More specifically, the resource management unit 62 subtracts the data size of the requested contents from the unused capacity 94 of the resource pool ID 91 specified at S904 in the resource pool management table 641. Furthermore, the resource management unit 62 adds a record to which the requested content ID 101 and the specified resource pool ID 102 are set to the intradomain content management table 642.

The request processing unit 81 in the distributor client 8 stores the contents distributed from the management server 2 in the resource pool of the storage 85. Then, the request processing unit 81 in the distributor client 8 distributes the distributed contents to the requestor client 8 based on the content distribution instruction at S909 (S910). Moreover, the storage management unit 82 in the distributor client 8 updates the client content management table 852. More specifically, the storage management unit 82 adds a record to which the content ID, the content name, and the data size that have been distributed along with the content at S907 are set to the client content management table 852.

The request processing unit 81 in the requester client 8 receives the contents from the distributor client 8 through the intradomain network 7, and reproduces or executes and outputs the contents to the output control unit 905 (S911). More specifically, the requestor client reproduces or executes the received contents by streaming without storing it in the storage.

In addition, in the example shown in the drawing, the distributor client 8 and the requestor client 8 are different clients 8. However, it is acceptable that the resource pool specified at S904 is the resource pool of the requestor client and the distributor client 8 and the requester client 8 are the same client. In this case, the requestor client (distributor client) stores and reproduces the contents distributed from the management server 2 at S910.

FIG. 20 is a process flow when the copying number has reached the upper limit (S902: YES in FIG. 19). In the process flow shown, since the copying number has reached the upper limit, requested contents are transferred from a client 8 in another local domain.

The local server management unit 23 in the management server 2 reads out the local server management table 33, and specifies the server ID 81 of the local server 6 having the requested content ID (S201). More specifically, the local server management unit 23 refers to the own content ID 83 of the local server management table 33, and specifies the server ID 81 having the requested content ID. Subsequently, the local server management unit 23 sends the specified server ID 81, and the data size of the contents stored in the content management table 31 to the requestor local server 6 (S202). Furthermore, the local server management unit 23 updates the local server management table 33. More specifically, the local server management unit 23 deletes the requested content ID from the own content ID 83 of the specified server ID 81. Then, the local server management unit 23 adds the requested content ID to the own content ID 83 of the server ID 81 of the requester local server 6.

The distribution processing unit 61 in the requester local server 6 receives the server ID of the local server 6 having the requested contents (hereinafter, ‘the source local server’) and the data size of the content from the management server 2. Subsequently, the distribution processing unit 61 specifies the resource pool ID to store the contents based on the received data size (S203). More specifically, the distribution processing unit 61 refers to the resource pool management table 641, and specifies the resource pool ID 91 that is greater than the data size received in the unused capacity 94.

Then, the distribution processing unit 61 sends distributor information including the address 95 of the specified resource pool ID 91 to the requestor client 8 through the intradomain network 7 (S204). Moreover, the distribution processing unit 61 sends the address 95 of the specified resource pool ID and the content ID to the source local server 6 through the intradomain network 7 and the interdomain network 4 (S205).

The distribution processing unit 61 in the source local server 6 refers to the intradomain content management table 642, and specifies the resource pool ID matching with the content ID sent. In addition, the distribution processing unit 61 reads out the resource pool management table 642, and specifies the address 95 of the specified resource pool ID (S206). Then, the distribution processing unit 61 sends a content distribution instruction to the client 8 having the specified address (hereinafter, ‘the source client’) through the intradomain network 7 (S207). Furthermore, the content distribution instruction includes the requested content ID and the address of the resource pool ID specified at S203. Moreover, the distribution processing unit 61 updates the intradomain content management table 642. More specifically, the distribution processing unit 61 deletes a record of the content ID sent and the specified resource pool ID from the intradomain content management table 642.

The request processing unit 81 in the source client 8 receives the content distribution instruction, reads the contents included in this instruction out of the resource pool of the storage 85, and transfers (sends) them to the storage of the client located at the address of the resource pool ID specified at S203 through the network interface unit 83 (S208).

More specifically, the request processing unit 81 sends the contents, and then deletes the contents from the resource pool. In addition, the request processing unit 81 sends the content ID 121, the content name 122, and the data size 123 of the contents stored in the client content management table 852 along with the contents. Subsequently, the request processing unit 81 sends the content ID 121, and then deletes the record such as the sent content ID from the client content management table 852.

The distribution processing unit 61 in the requestor local server 6 instructs the client 8 of the resource pool ID specified at S203 (hereinafter, ‘the distributor client’) to distribute the contents sent from the source client 8 (S209). Furthermore, the content distribution instruction includes the requested content ID and the address of the requestor client 8.

Moreover, the resource management unit 62 in the requestor local server 6 updates the resource pool management table 641 and the intradomain content management table 642. More specifically, the resource management unit 62 subtracts the data size of the requested contents from the unused capacity 94 of the resource pool ID 91 specified at S903 in the resource pool management table 641. In addition, the resource management unit 62 adds a record to which the requested content ID 101 and the specified resource pool ID 102 are set to the intradomain content management table 642.

The request processing unit 81 in the distributor client 8 stores the contents distributed from the source client 8 in the resource pool of the storage 85. Then, the request processing unit 81 distributes the distributed contents to the requester client 8 based on the content distribution instruction at S209 (S210). Furthermore, the storage management unit 82 updates the client content management table 852. More specifically, the storage management unit 82 adds a record to which the content ID, the content name, and the data size distributed along with the content at S208 are set to the client content management table 852.

The request processing unit 81 in the requester client 8 receives the contents from the distributor client 8 through the intradomain network 7, and reproduces or executes and outputs the contents to the output control unit 905 (S911) More specifically, the requestor client reproduces or executes the received contents by streaming without storing them in the storage 85.

Moreover, in the example shown in the drawing, the requestor client 8 and the distributor client 8 are different clients 8. However, it is acceptable that the resource pool specified at S203 is the resource pool of the requestor client 8 and the distributor client 8 and the requestor client 8 are the same client. In this case, the requester client (‘distributor client’) stores and reproduces or executes the contents distributed from the source client 8 at S210.

The embodiment has been described above.

In the embodiment, the storage 85 in the client 8 used by the end user is managed and utilized as the content storing region (resource pool) of the content distribution system, and thus the addition of IT resources can be suppressed small. More specifically, in the typical content distribution system, when the service area is expanded, it is necessary that the local domains 5 are set sequentially and the storage devices that store contents are newly prepared for every local domain 5. However, in the embodiment, the local server 6 in the local domain 5 can distribute contents to the individual clients 8 in the local domain 5 without preparing any storage devices to store the contents. Accordingly, the local domain 5 can be constructed with a little addition of IT resources (the local servers 6) as compared with the typical content distribution system.

Furthermore, in the embodiment, the contents stored in the storage 85 (resource pool) in any clients 8 in the same the local domain 5 are distributed to the other clients 8 in the same local domain through the intradomain network 7. Then, the other clients reproduce the distributed contents by streaming without storing them in the storage 85. More specifically, since the same contents are not stored in the storage 85 of the individual clients 8 with no overlaps in the local domain 5, the effective utilization of the storage 85 (the resource pool) can be intended.

In addition, the present invention is not limited to the embodiment, which can be modified variously within the scope of the teachings. For example, in the embodiment, the management server 2 or the source client 8 directly copies or transfers the contents to be copied or transferred to the distributor client 8, not through the local server 6. However, it is acceptable that the management server 2 or the source client 8 copies or transfers the contents to the distributor client 8 through the management server 6.

What is claimed is:

1. A content distribution system comprising:
a distribution server which instructs distribution of contents; and
at least one client, wherein
the individual clients have:
a client storage which stores data;
registration means which registers a part or all of the client storage in the distribution server as a resource pool to store the contents; and
requesting means which accepts a distribution request for contents and sends the distribution request for the contents to the distribution server, and
the distribution server has:
distribution server storing means which stores a resource pool management table that manages the resource pool registered by the individual clients, and a content management table that associates the contents with the resource pool storing the contents;
request accepting means which accepts a distribution request for contents from the individual clients;
specifying means which reads out the content management table and specifies the resource pool storing the contents accepted by the request accepting means; and
distribution instructing means which sends a distribution instruction for the contents to a client having the resource pool specified by the specifying means.

2. The content management system according to claim 1, wherein
the distribution server and at least one client are provided for each of a plurality of given areas.

3. The content management system according to claim 2, further comprising a management server which manages the distribution server and at least the one client in a plurality of the given areas, wherein
the management server has a server storage which stores the contents, and
when the content management table does not have the resource pool which stores the content accepted by the request accepting means, the specifying means in the distribution server requests the management server to distribute the contents accepted by request accepting means.

4. The content distribution system according to claim 3, wherein
the management server further comprises:
management server storing means which stores a distribution management table including an upper limit number that the contents can be distributed to each of the resource pools and a distribution number that the contents have already been distributed to each of the resource pools at each of the contents, and a server management table having identification information of the distribution server and a list of contents stored in each of the resource pools in a given area to which the distribution server belongs at each of the distribution servers; and
determination means which accepts a distribution request for contents from the distribution server, reads out the distribution management table, and compares the upper limit number of the contents accepted by the distribution request with the distribution number, wherein
the determination means distributes the contents accepted by the distribution request from the server storage when the upper limit number is smaller than the distribution number, and
the determination means reads out the server management table, and sends identification information of a distribution server having the contents accepted by the distribution request to the distribution server having sent the distribution request when the upper limit number is the same as the distribution number.

5. The content distribution system according to claim 3, wherein
the resource pool management table of the distribution server further comprises an unused capacity of the individual resource pools, wherein
the specifying means of the distribution server specifies the resource pool which stores the contents accepted by the request accepting means based on the unused capacity of the resource pool management table when the content management table does not store the resource pool which stores the contents accepted by the request accepting means.

6. A content distribution method in a content distribution system having a distribution server which instructs distribution of contents and at least one client, wherein
the individual clients have a client storage which stores data and a client processing unit, wherein
the client processing unit performs:
a registration step of registering a part or all of the client storage in the distribution server as a resource pool which stores the contents; and
a distribution request step of accepting a distribution request for contents and sending the distribution request for the contents to the distribution server, and
the distribution server has:
a distribution server storing means which stores a resource pool management table that manages the resource pools registered by the individual clients and a content management table that associates the contents with the resource pool storing the contents; and
a server processing unit, wherein
the server processing unit performs:
a request accepting step of accepting a distribution request for the contents from the individual clients;
a specifying step of reading out the content management table and specifying the resource pool storing the contents accepted at the request accepting step; and
a distribution instructing step of sending a distribution instruction for the contents to the client having the resource pool specified at the specifying step.
